(19) United States
(12) Patent Application Publication
(10) Pub. No.: US 2016/0288952 A1
(43) Pub. Date: Oct. 6, 2016

(54) DISPENSING DEVICE

(71) Applicant: Renapharma AB, Uppsala (SE)

(72) Inventor: Caroline Danielson, Stockholm (SE)

(21) Appl. No.: 14/740,341

(22) Filed: Jun. 16, 2015

(30) Foreign Application Priority Data
Apr. 1, 2015 (EP) 15162234.7

(51) Int. Cl. B65D 21/02; A61J 7/04; B65D 25/04; A61J 1/03

(52) U.S. Cl. CPC B65D 21/0228; A61J 1/03; A61J 7/04; B65D 25/04; A61J 2205/20

(57) ABSTRACT

A dispensing device (1) having a plurality of trays (2) for dispensing of doses of medicaments, the device (1) comprising:
(a) a number of trays (2) each having a side wall (2a) and stacked onto each other provided with and divided into storage compartments (3), each storage compartment (3) adapted to contain one predetermined dose of one or several medicaments, which trays (2) can be mounted/dismounted to each other (2), wherein each trays is fitted with an upper (4) and lower (5) mounting means (4, 5) adapted to fit the trays (2) to each other to form the dispensing device (1), wherein the device further comprises an upper (6) and a lower (7) end cover adapted to be fit to an upper tray (2) and a lower tray (2), respectively. The trays (2) can easily be mounted to each other by a user in a few simple handgrips by means of the mounting means (4, 5) adapted to fit the trays (2) to each other to form the dispensing device (1). The dispensing device (1) can also easily be dismounted, is very flexible and can be adapted depending on an individual user's needs.

### TECHNICAL FIELD

The present invention is related to a dispensing device for storing and/or dispensing of doses of medicaments. In particular the present invention is related to a dispensing device having a plurality of trays, which can be mounted or dismounted to each other by a user.

### BACKGROUND

Timely medication of patients is pivotal and poses a considerable challenge to the medical society. Patients commonly forget to take their medicaments, in particular elderly patients and those required to adhere to a complicated scheme of administration with several doses of medicaments a day, sequentially, sometimes of different medicaments as well.

Since the pharmacodynamics of various medicaments differs considerably, administration of medicaments at specific times, say four times a day, may be necessary or advisable.

Because of that reason, but also for other reasons, dispensing devices having a plurality of storage compartments, each storage compartment adapted to contain one predetermined dose of one or several medicaments and related to administration of medicaments at specific times have been manufactured and sold in large numbers.

### SUMMARY OF THE INVENTION

According to an embodiment of the present invention, there is provided a dispensing device having a number of trays for storing and/or dispensing of doses of medicaments. The device has the trays stacked onto each other. The trays can be mounted/dismounted to each other. Each tray has a side wall and is divided into storage compartments. Each storage compartment is adapted to contain one predetermined dose of one or several medicaments. Each trays is fitted with upper and lower mounting means, respectively, adapted to fit the trays to each other to form the dispensing device, wherein the dispensing device further comprises an upper and a lower end cover adapted to be fit to an upper and a lower end tray, respectively.

According to an aspect, the present invention provides a dispensing device for medicaments, tablets and/or health care products. The dispensing device comprises a number of trays for storing and/or dispensing of doses of medicaments. The trays can easily be mounted to each other by a user in a few simple handgrips by means of the mounting means adapted to fit the trays to each other to form the dispensing device. The dispensing device can also easily be dismounted. The dispensing device is very flexible and can be adapted depending on an individual user's needs.

According to an embodiment, the dispensing device has a number of trays corresponding to a period of time as the same number of days. Each tray is provided for storing one day's consumption of medicaments and is labeled with the name of that day, say Monday, or any other day from Monday-Sunday. Since the dispensing device is very flexible and easily can be adapted depending on the individual user's needs, a user may mount a dispensing device having only the trays, as well as upper and a lower end cover that are needed for a particular period of time. This is a great advantage compared to fix prior art bulky dispensing devices, since the user only has to carry a dispensing device for the period of time that is actually needed.

According to an embodiment, the dispensing device comprises at least one dividing wall for each tray and adapted to be mounted into the tray comprising receiving grooves for fitting the dividing walls to form the storage compartments. The dividing wall or walls is/are easy to fit because of the receiving grooves. This embodiment is particularly useful for users needing 1-4 daily doses of medicaments.

According to an embodiment, the dispensing device further comprising a lid adapted to be rotatably mounted to a tray and cover all, but one of the compartments. The lid can be rotated such that another compartment is opened and the medicaments in that compartment can be administered, for instance at another point in time the same day. This embodiment is particularly useful when administering two or more doses the same day, since only the dose (medicaments) of the non-covered and hence open compartment are administered each time. Typically, each tray comprises a lid, respectively.

Each tray may on its side wall on an outer side comprise a ridge, wherein the trays when mounted form the ridge extending in a longitudinal direction on an outside of the dispensing device.

The trays can also optionally be color coded (indicated by different grey scales) and/or coded with other sensing means for guiding also a blind user not being able to see the colors. Typically, the color follows a concept, wherein one and the same day always has the same color, also related to other products such as computer application programs or other computer programs for administering the dispensing device. The computer program product can be arranged to present the trays and the doses virtually as they are present in the real dispensing device.

Further embodiments, their advantages and details of specific components will be given by the embodiments described below.

### BRIEF DESCRIPTION OF DRAWING FIGURES

FIG. 1 is a perspective view from above of a dispensing device according to an embodiment of the present invention;

FIG. 2a is a frontal view of a dispensing device according to an embodiment of the present invention, wherein the device has a number of trays corresponding to a period of time as the same number of days, herein seven days;

FIG. 2b illustrates the same device as in FIG. 2a, wherein the device has a number of trays corresponding to a period of time as the same number of days, herein four days;

FIG. 2c illustrates the same device as in FIG. 2a, wherein the device has a number of trays corresponding to a period of time as the same number of days, herein three days;

FIG. 3a illustrates, in a perspective view from above, one tray without dividing walls being mounted yet;

FIG. 3b illustrates, in a perspective view from above, the same tray as illustrated in FIG. 3a with one dividing wall being mounted; is a perspective view of a dispensing device according to an embodiment of the present invention

FIG. 3c illustrates, in a perspective view from above, the same tray as illustrated in FIG. 3a or 3b with two dividing walls being mounted;

FIG. 4a illustrates, in a view from a side, the same tray as illustrated in FIG. 4a in an upright use-position showing upper mounting means of bayonet type;

FIG. 4b illustrates, in a view from a side, the same tray as illustrated in FIG. 4a from the rear side, in an inverted position, inverted compared to the upright use-position illustrated in FIG. 4a, showing lower mounting means of bayonet type adapted to engage with upper mounting means of bayonet type of an adjacent tray;

FIGS. 4c and 4d illustrates, in a perspective view from below, the same tray as illustrated in FIG. 4a in an upright use-position showing how two trays are mounted to each other;

FIG. 5a illustrates an embodiment of the device, in a perspective view a tray with a lid before attaching the lid to the tray;

FIG. 5b illustrates the same tray with the lid attached; and

FIG. 6 illustrates a system comprising, a mobile communication device and a computer for operating with a dispensing device according to an embodiment of the present invention.

Embodiments of the present invention will now be described in more detail with reference to the accompanying drawings.

The embodiments shall merely be seen as an illustration of the spirit and scope of the current invention, and in no way whatsoever as a limitation.

### DETAILED DESCRIPTION OF EMBODIMENTS

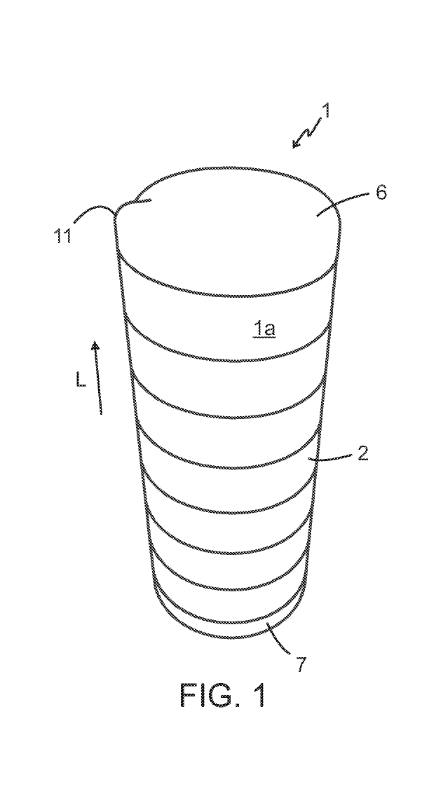

Now is referred to FIG. 1 illustrating a perspective view of a dispensing device according to an embodiment of the present invention.

In FIG. 1, there is illustrated a dispensing device 1 having a number of trays 2 for storing and/or dispensing of doses of medicaments (not shown in this FIG). The dispensing device 1 has the trays 2 stacked onto each other. The trays 2 can be mounted or dismounted to each other, wherein in this FIG. 1, they are shown mounted and fitted to each other. The dispensing device further comprises an upper 6 and a lower 7 end cover adapted to be fit to an upper tray 2 and a lower end tray 2, respectively. The trays 2 per se will be illustrated and described later on. Note that the dispensing device is also equally suitable for tablets and health care products or may even receive and store cartridges with such products as well as other medicaments, including syrups, as will be described later on.

The upper 6 end cover closes the most upper end tray 2. The lower 7 end cover closes a rear side of the lowest end tray 2 and can optionally be adapted to contain additional medicaments, which may be needed in some cases. The upper 6 and lower 7 end cover may comprise label(s) and/or printed text.

According to an embodiment, as illustrated in FIG. 1, an outer surface 1a of the device 1 essentially forms a cylindrical tube, but according to an alternative embodiment the outer surface 1a may form another type of surface, such as a square or hexagonal surface for instance, of which the latter are not illustrated in any drawing figure but nevertheless are encompassed by the scope of the present invention.

Typically, the dispensing device comprises a ridge 11 adapted such that the dispensing device cannot roll when placed on a surface. Another advantage is that the ridge may act as a gripping means to assist, by increasing the grip for instance, a user to mount or dismount the dispensing device. Typically the user mounts or dismounts the dispensing device by a screwing/turning hand-grip.

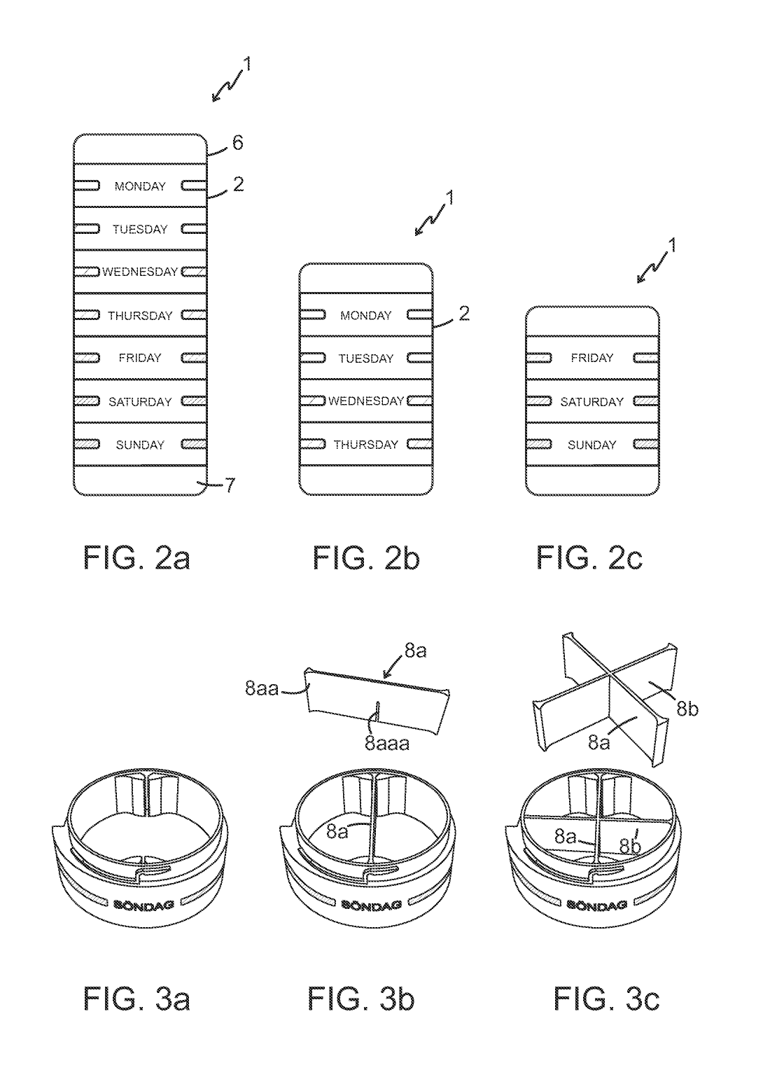

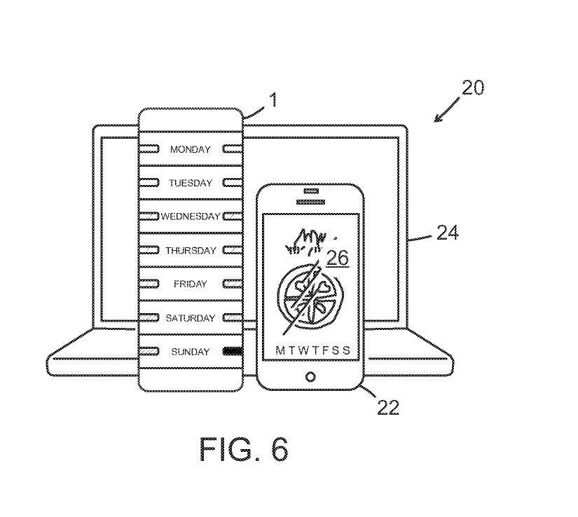

FIG. 2a is a frontal view of a dispensing device according to an embodiment of the present invention, wherein the device has a number, herein seven, of trays 2 corresponding to a period of time as the same number of days, herein seven days, i. e. a week. Each tray is typically provided for storing one day's consumption (for one user) of medicaments and is labeled with the name of that day, say Monday or Sunday, but in case an additional amount of medicaments is required, more than one tray for the one and same day, say Monday-Monday can be used. Thus, a dispensing device for a week's consumption (for a user such as a patient) may typically contain seven trays for Monday-Friday or if as an example, an additional tray for one day is need, eight trays are required. As shown in FIG. 2a the trays 2 can also optionally be color coded (indicated by different grey scales) and/or coded with other sensing means for guiding also a blind user not being able to see the colors. Typically, the color follows a concept, wherein one and the same day always has the same color, also related to other products such as computer application programs or other computer programs for administering the dispensing device (See FIG. 6).

Since the dispensing device is very flexible and easily can be adapted depending on the individual user's needs, a user may mount a dispensing device having only the trays, as well as upper and lower end cover, that are needed for a particular period of time, which may not always involve consecutive days, say Monday-Wednesday-Friday. This is not illustrated in any drawing figure, but nevertheless encompassed by the scope of the present invention.

FIG. 2b illustrates the same device as in FIG. 2a, wherein the dispensing device has a number of trays corresponding to a period of time as the same number of days, herein four days, herein Monday-Thursday.

FIG. 2c illustrates the same device as in FIG. 2a, wherein the device has a number of trays corresponding to a period of time as the same number of days, herein three days, for instance a week-end from Friday-Sunday.

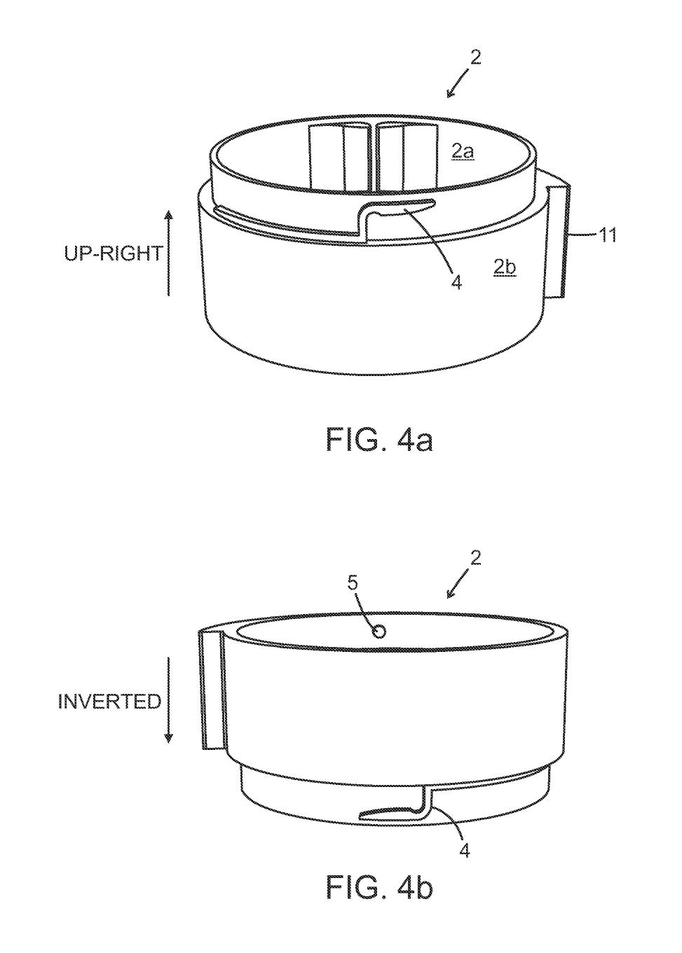

FIG. 3a illustrates, in a perspective view from above, a tray 2 without any dividing wall or walls being mounted yet.

FIG. 3b illustrates, in a perspective view from above, the same tray as illustrated in FIG. 3a with one dividing wall 8a being mounted. The inset figure above FIG. 3b illustrates the dividing wall 8a per se, herein the form of a rectangular wall 8a adapted to be mounted into the tray 2 comprising receiving means 9 such as receiving grooves for fitting the dividing wall 8a to form the storage compartments 3a-d. The dividing wall 8a comprises means 8aa, herein thicker portions, adapted to fit into the grooves 9. These means are only examples and not intended to be limiting the scope of the invention. Thus, the invention is not limited to the embodiments and examples given in any of the drawing FIGS. 3a-c.

FIG. 3c illustrates, in a perspective view, the same tray as illustrated in FIG. 3a or 3b with two dividing walls being mounted. The tray 2 can comprise one or two pair of grooves 9, of which herein only one pair is shown, but without limitation to only one. The walls 8a, 8b are also adapted to be mounted together perpendicular to each other and can therefore comprise in-cuts 8aaa or any other suitable means adapted for this.

The tray 2 is divided into storage compartments, herein four, 3a-d or has a space adapted to be filled with cartridges. In this way, each tray 2 is provided for storing 1-4 daily doses of medicaments. The number of walls is not limited to two only and depends only on the number of compartments 3 needed. Typically, a dispensing device 1 may be sold with 7 trays 2, lower and upper end covers 6, 7, and 14 dividing walls 8a, 8b. In this way, a daily consumption of medicaments can be divided into four doses per day by means of two dividing walls 8a, 8b.

Alternatively, a cartridge (not shown) may be placed in the tray 2, wherein the cartridge provides the storage compartments instead. The cartridges have a shape which enables them to be easily removed from the device and facilitates easy handling by a person with impaired motor skills. The size of the compartments and/or the cartridges is suitable for holding doses of one or several medicaments.

In use, the dispensing device can be pre-loaded with medicaments for more than one instance of administration, either by the patient himself, or by other personnel for instance filling cartridges. Then, a cartridge can fill up the space of all the compartments of a tray. In one embodiment, the device is circular in shape with the compartments or cartridges filling out the volume from the center of the device. Alternatively, cartridges may fill out part of the volume, e.g. part of a sector of the circle. An advantage with this embodiment is that the cartridges can hold compositions other than tablets, such as powders, liquids, syrups.

A computer application program product, when loaded and run on a user's mobile communication device can provide an alarm and a corresponding picture of the tray 2 in which storage compartment the medicament is (See FIG. 6).

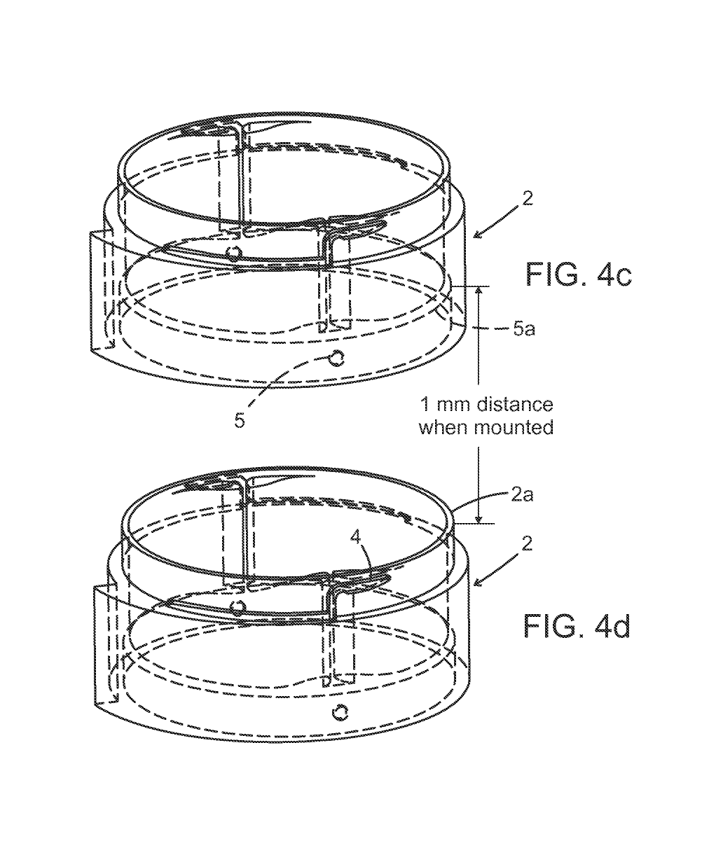

Now is referred to FIGS. 4a and 4b.

FIG. 4a illustrates, in a view from a side, the same tray in an upright use-position showing upper mounting means 4 of bayonet type.

FIG. 4b illustrates, in a view from a side, the same tray as illustrated in FIG. 4a from the rear side, in an inverted position, inverted compared to the upright use-position illustrated in FIG. 4a, showing lower mounting means 5 of bayonet type adapted to engage with upper mounting means of bayonet type of an adjacent tray (see FIGS. 4c and 4d). The upper and lower mounting means 4, 5 can alternatively be of other type than of bayonet type such as screw-threads (not shown), or sliding rails (not shown).

Each tray 2 is provided with an upper 4 (see FIG. 4a) and lower 5 (see FIG. 4b) mounting means, respectively, adapted to engage with each other 4, 5 and fit the trays 2 to each other to form the dispensing device 1 as illustrated and described in relation to the embodiment in FIG. 1, for instance. The upper 6 end cover is provided with a lower mounting means 5 only and the lower end cover 7 is provided with an upper 4 mounting means 5 only. Note that the measurements given in the drawing figures may not necessarily be to 1:1 scale, or may be smaller, or larger, and are given only to illustrate and explain the invention.

Since mounting means of bayonet type, as well as of screw-thread type, and the operation thereof are well-known for the skilled person they are not further described and explained.

FIGS. 4c and 4d illustrates, in a perspective view from below, the same tray as illustrated in FIG. 4a in an upright use-position showing how two trays 2 are mounted stacked to each other before being fitted to each 2, 2 other. A distance from a bottom part 5a of an upper tray 2 to an upper edge 2a of a lower tray can be 1 mm for instance, which is indicated in the drawing FIGS. 4c-4d, but also other distances are possible without departing from the inventive concept.

According to an embodiment, the mounting means 4, 5 can be adapted to provide a snap-fitting providing a hearable click-sound when, properly, engaged to fit one tray 2 to another tray 2. This embodiment is useful to assist a user to avoid using too much or too small force when mounting or dismounting the dispensing device.

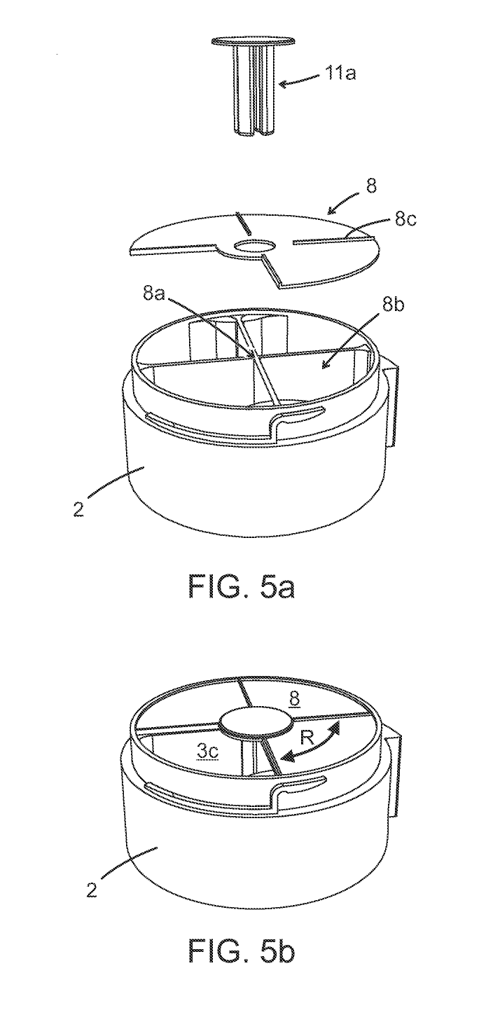

Now is referred to FIGS. 5a and 5b. FIG. 5a illustrates an embodiment of the device, in a perspective view a tray with a lid 8 before attaching the lid 8 to the tray 2 and FIG. 5b illustrates the same tray with the lid 8 attached. The lid 8, provided as an “inner lid” having a smaller diameter than a diameter of the tray is adapted to be rotatably mounted, for instance by, but not limited to, a plug snap fittings means 11a, attaching the lid 8 to the tray 2 via the dividing walls 8a, 8b and cover all, but one of the compartments 3c in the tray (See FIG. 5b), which is non-covered. The lid is adapted to be rotated by means of a user, for instance applying a light rotating movement by touching the lid with her/his finger (indicated by an arrow R). The lid can be transparent and/or may have a solid circumferential ridge (not shown).

When two or more doses are needed per day, this embodiment is particularly useful since only the medicaments in the open, non-covered compartment 3c are dispensed when a user turns the tray in a non-upright, or inverted position, to take her/his medicament

The lid 8, as well as, the plug 11a, can be of made of plastics such as ABS for instance and have a thickness of 0.5-0.75 mm, for instance 0.75. Reinforcement, and/or gripping rills 8c having a height up to 0.75 mm can be provided.

According to an embodiment, a GPS-transmitter can further provided into the lower 7 end cover and adapted such that the dispensing device 1 can be tracked by means of a user mobile communication device having an application program product adapted for tracking GPS-signals.

The dispensing device may be manufactured through for example an injection molding technique. The device may be made out of plastic material, for instance transparent plastic, for easy identification of medicaments through the walls, or of colored plastics, such as white color, for an appealing appearance. The device may be constructed of a polymer that gives a surface which is easy to handle, with regard to for example elderly people.

As an example, the plastic material can be polypropylene mixed with lime for all components, but the lid which can be made polypropylene without lime, but without any limitation thereto.

As an example, the dispensing device can be approximately 15 cm in height and 5 cm in outside diameter, but without any limitation thereto.

Without dividing walls, each tray with side walls has a volume of approximately 25 cm³. With one dividing wall fitted, each compartment has a volume of approximately 13 cm³. With two dividing walls fitted, i. e. four compartments for medicaments, each compartment has a volume of approximately 6.45 cm³. The example volumes are the result of independent user tests.

The dispensing device corresponds to European Commission directive 93/42/EEC for medical technical products Class I.

Now is referred to FIG. 6. FIG. 6 illustrates a system 20 comprising, a mobile communication device 22 and a computer 24 for operating with a dispensing device 1 according to an embodiment of the present invention.

The dispensing device 1 is typically adapted to operate together with a computer program product 26 when loaded and run on the mobile communication device 22. The computer program product 26 is adapted to instruct the user which compartment is to be dispensed at what time. The dispensing device and the computer application program product have the same colour coding to provide a user-friendly application and a quick learning of the user. Also a list of medicaments, alarm, reminder and registration of doses taken as well as historical data can be provided but the dispensing device is a completely stand-alone device that can alternatively be used without the computer application product 26.

1. A dispensing device for storing and/or dispensing of doses of medicaments, the device (1) comprising:
a number of trays each tray having a side wall and stacked onto each other, and being provided with and divided into storage compartments, each storage compartment adapted to contain one predetermined dose of one or several medicaments, which trays can be mounted/dismounted to each other, wherein each tray is fitted with an upper and lower mounting means adapted to fit the trays to each other to form the dispensing device, wherein the device further comprises an upper and a lower end cover adapted to be fit to an upper and a lower end tray, respectively.

2. The dispensing device according to claim 1, wherein the dispensing device has a number of trays corresponding to a period of time as the same number of days.

3. The dispensing device according to claim 1, comprising at least one dividing wall for each tray and adapted to be mounted into the tray comprising receiving grooves for fitting the dividing walls to form the storage compartments.

4. The dispensing device according to claim 3, comprising two dividing walls for each tray.

5. The dispensing device according to claim 1, wherein the upper and lower mounting means are of bayonet type and adapted to engage with each other.

6. The dispensing device according to claim 1, wherein the mounting means are adapted to provide a snap-fitting providing a hearable click sound when engaged to fit one tray to another tray.

7. The dispensing device according to claim 1, further comprising a lid adapted to be rotatably mounted to a tray and cover all, but one of the compartments in the tray.

8. The dispensing device according to claim 1, wherein each tray on its side wall on an outer side comprises a ridge, wherein the trays when mounted forms the ridge extending in a longitudinal direction on an outside of the dispensing device.

9. The dispensing device according to claim 1, wherein an outer surface of the device essentially forms a cylindrical tube.

10. The dispensing device according to claim 8, wherein the ridge is adapted such that the dispensing device cannot roll when placed on a surface.

11. The dispensing device according to claim 1, wherein an outer surface of the dispensing device essentially forms a square tube.

12. The dispensing device according to claim 1, wherein the lower end cover is adapted to contain additional medicaments.

13. The dispensing device according to claim 12, wherein to GPS-transmitter is provided into the lower end cover and adapted such that the device can be tracked by means of a user mobile communication device having an application program product adapted for tracking GPS-signals.

14. The dispensing device according to claim 2, wherein the trays are individually color coded, such that each day has its individual color code.

15. The dispensing device according to claim 1, wherein labels are provided with braille indication for blind users.
